(19) United States
(12) Patent Application Publication
(10) Pub. No.: US 2006/0286526 A1
(43) Pub. Date: Dec. 21, 2006

(54) Vehicle for experimental demonstration of laws of motion

(76) Inventors: Marshall Montgomery, Napa, CA (US); Grant M. Gardner, Pepperell, MA (US); Matthew Gilliland, Penn Valley, CA (US); Dan A. Bluestein, Berkeley, CA (US); Laurence E. Malone, Berkeley, CA (US); Linda L. De Lucchi, Berkeley, CA (US)

Correspondence Address: DAVIS & BUJOLD, P.L.L.C., 112 PLEASANT STREET, CONCORD, NH, 03301, US

(21) Appl. No.: 11/361,446

(22) Filed: Feb. 23, 2006

Related U.S. Application Data
(60) Provisional application No. 60/685,339, filed on May 27, 2005.

(51) Int. Cl. G09B 23/08

(52) U.S. Cl. 434/302

(57) ABSTRACT

A vehicle for performing an experiment demonstrating a Newtonian law of motion, including capturing data representing vehicle velocity over time during execution of an experiment, the vehicle comprises an interval timer for generating a time interval output representing equal intervals of time; a velocity indicating mechanism for generating a velocity output representing a velocity of the vehicle when traveling along a path during performance of the experiment; and a memory mechanism for recording the time interval output and the velocity output during performance of the experiment, the recorded time interval output and velocity output being recorded for use in at least one calculation demonstrating the Newtonian law of motion.

This application claims priority from U.S. provisional application Ser. No. 60/685,339 filed May 27, 2005.

### FIELD OF THE INVENTION

The present invention is relates to a vehicle for demonstrating the laws of motion and, in particular, to a vehicle for demonstrating the laws of motion to students, such as acceleration and momentum, by experimentation during which the vehicle collects and preserves information relating to motion of the vehicle under experimental conditions.

### BACKGROUND OF THE INVENTION

A common part of the teaching basic physical sciences in schools at various levels is the demonstration of physical principles through experimentation wherein the students gather experimental evidence through which the physical principles being taught can be derived or proven, such as Newton's laws of motion.

There are what may be termed “classic” experiments and experimental methods for such purposes, such as demonstrating Newton's force/acceleration relationships. The materials and devices typically used for these experiments have come to be regarded as unsatisfactory because they do not, in general, provide data that is sufficiently accurate and consistently reliable from the experiments. For example, the force/acceleration experiment is typically conducted by rolling a car or ball or similar type of object down a ramp and measuring distance and time by eye using, for example, measurement marks along the ramp and a stopwatch. The incidental variables in such measurements, however, often result in unreliable data that cannot be used to prove convincingly Newton's law of force and acceleration. While more accurate experimental equipment is available, it tends to be much more costly and significantly more complex to use and is thereby not realistically suitable for use with students to teach introductory physical science classes, particularly at lower grade levels.

The present invention addresses and provides a solution for these and other related problems of the prior art.

### SUMMARY OF THE INVENTION

The present invention is directed to a vehicle for performing experiments demonstrating a Newtonian law of motion, including generating or capturing data representing vehicle velocity over time while conducting or execution of an experiment.

According to the present invention, the vehicle includes an interval timer for generating a time interval output representing equal intervals of time, a velocity indicating mechanism for generating a velocity output representing a velocity of the vehicle while traveling along a path during performance of an experiment, and a memory mechanism for recording the time interval output and the velocity output during performance of the experiment, the recorded time interval output and velocity output being stored for use in calculations demonstrating the Newtonian law of motion.

In a first embodiment of a vehicle of the invention, the interval time includes a motor and drive train rotationally driving a reciprocal driver at a fixed rotational rate, the reciprocal driver having at least one driver arm extending therefrom and the velocity indicating mechanism includes a marker for marking a visual indication on a surface contacted by the marker and a reciprocating marker holder slidably mounted in the vehicle for a vertical reciprocating motion, the marker being retrained in the marker holder and the marker holder including a driver flange extending radially from the marker holder to be periodically engaged by the at least one driver arm of the reciprocating driver, and the memory mechanism is a recording strip extending along the path traveled by the vehicle during performance of the experiment. Rotation of the reciprocating driver brings the at least one driver arm into periodic engagement with the drive flange of the marker holder at fixed intervals determined by the rotational rate or speed of the reciprocating driver and, upon each engagement of the driver flange by the at least one driver arm, the marker holder is driven vertically downward so that the marker contacts the recording strip and makes a corresponding visual indication thereupon, so that the distance between successive visual indications represents a velocity of the vehicle along the path traveled during performance of the experiment, e.g., closer spacing between adjacent marks indicates that the vehicle is decelerating while further spacing between adjacent marks indicates that the vehicle is accelerating.

In further implementations of the first embodiment of the vehicle, the vehicle further includes a frame for slidably mounting the reciprocating marker holder in the vehicle for a vertical reciprocating motion and the velocity indicating mechanism further includes a return spring engaging between the vehicle and the reciprocating marker holder for returning the reciprocating marker holder to an upper vertical position when the at least one driver arm of the reciprocating driver disengages from the driver flange of the reciprocating marker holder. The reciprocating marker holder may further include a retainer cap located at an upper end of the reciprocating marker holder to retain the marker in the reciprocating marker holder and a bias spring located between the retainer cap and the marker for resiliently biasing the marker towards a lowermost position within the reciprocating marker holder so that a nib of the marker extends downwards through a nib opening in a bottom end of the reciprocating marker holder.

In a further embodiment of a vehicle of the present invention, the interval timer includes a clock generating a clock output at fixed time intervals and the velocity indicating mechanism includes a velocity indicator generating a velocity code output representing a sequence of equal distance intervals along the path at a rate representative of a velocity of the vehicle along a path in performance of the experiment and a counter responsive to the velocity code output and the clock output for counting a number of equal distance intervals occurring during each fixed time interval and generating a corresponding counter output. The memory mechanism includes a memory responsive to the counter output and to the clock output for storing a counter output for each fixed time interval, wherein each recorded counter output represents a number of equal distance intervals traveled by the vehicle during a corresponding fixed time interval and wherein the recorded counter outputs may be subsequently read from the memory for use in calculations demonstrating the Newtonian law of motion.

In a further implementation of the second embodiment, the velocity indicator includes a disk mounted on an axle of the vehicle to rotate at a rate determined by a rate of rotation of at least one wheel of the vehicle as the vehicle travels along the path during performance of the experiment and the velocity code output is generated by velocity code markings located on a circumference of the disk and sensed by a code marking sensor so that the velocity code output is a sequence of pulses indicating equal distance intervals traveled by the vehicle during performance of the experiment.

### BRIEF DESCRIPTION OF THE DRAWINGS

The foregoing and other objects, features and advantages of the present invention will be apparent from the following description of the invention and embodiments thereof, as illustrated in the accompanying figures, wherein:

FIGS. 1A and 1B are respectively side and bottom diagrammatic views of a vehicle of the present invention;

FIG. 1C is a diagrammatic view of a basic experimental setup showing the vehicle traveling down an inclined surface;

FIG. 2 is a diagrammatic cross sectional view of a reciprocating marker assembly of the vehicle;

FIGS. 3A, 3B and 3C are time sequence drawings illustrating the operation of the reciprocating marker assembly;

FIGS. 4A and 4B are respectively top and side diagrammatic views of a second embodiment of the present invention; and

FIGS. 4C and 4D are respectively timing diagram and a block diagram of a measurement mechanism of the second embodiment of the present invention.

### DETAILED DESCRIPTION OF THE INVENTION

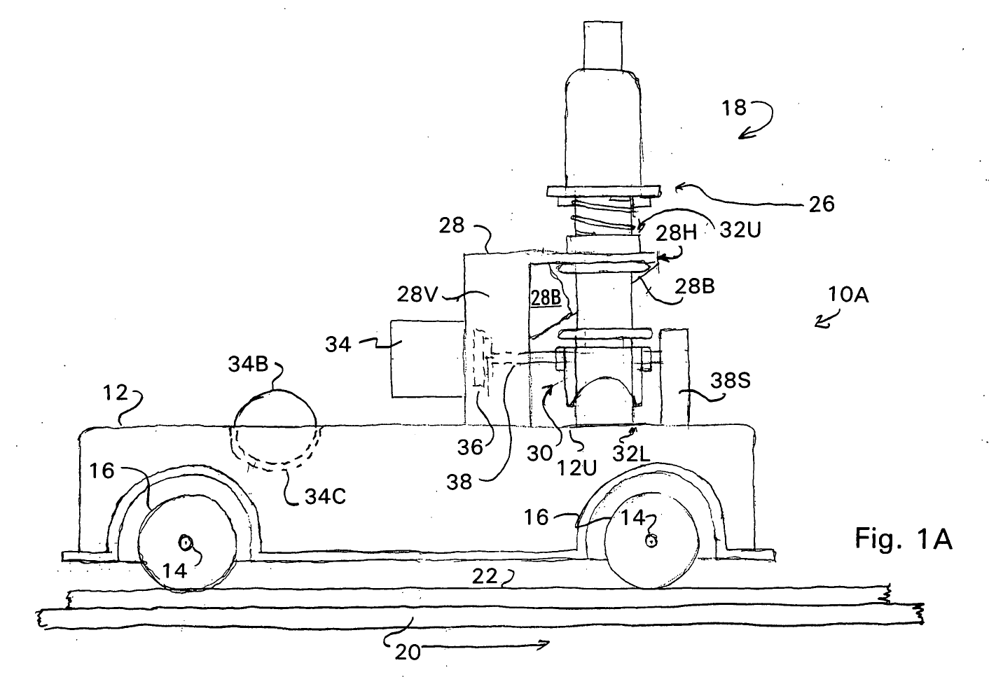

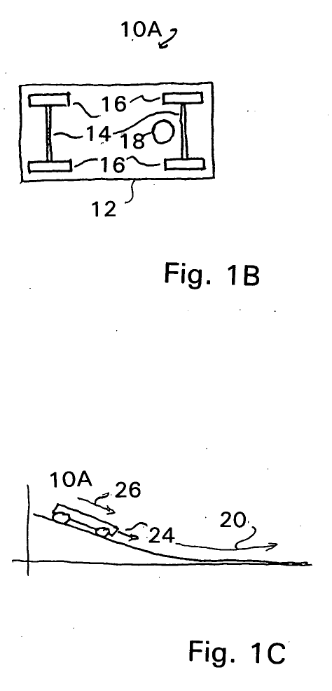

Referring to FIGS. 1A, 1B and 1C, therein are respectively shown diagrammatic side and bottom views of a first exemplary embodiment of an Experiment Demonstration Vehicle (EDVehicle) 10A of the present invention. As will be described in the following, an EDVehicle 10A may used, for example, to demonstrate Newton's force/acceleration relationships while providing experimental data with significantly increased accuracy and consistency at a reasonable cost.

As may be seen in FIGS. 1A and 1B, an EDVehicle 10A of the present invention is essentially a vehicle or car-like device for demonstration the Newtonian force/acceleration/time/speed relationships through the classic experiment rolling a car or ball or some other type of object down a ramp and measuring the distance traveled per unit time. As such, an EDVehicle 10A includes a car-like Body 12 having an Axle 14 at adjacent each opposed end wherein each Axle 14 fixedly supports a Wheel 16 at each end of the Axle 14 and wherein the Body 12 is typically in the shape of a rectangular box having a top but open at the bottom. The Axle 14, with the Wheel 16 affixed thereto, are designed to be freely rotatable with only a small amount of friction and a pair of bearings, for each Axle 14, may be employed to facilitate such free rotation. Within the spirit and scope of the invention, it is to be appreciated that other types, sizes, shapes, etc., of vehicles would also be suitable for use with the present invention.

According to the illustrated embodiment of the present invention, the EDVehicle 10A further includes a Measurement Mechanism 18 for determining equal time intervals as the EDVehicle 10A travels along a Path 20 and for making marks on a Record Strip 22 extending along the Path 20 at those equal time intervals as the EDVehicle 10A travels along the Record Strip 22. As a result, the Record Strip 22 will provide a visual record of distance traveled per unit time by recording the position of the EDVehicle 10A along the Path 20 at the equal time intervals determined by the mechanism of the EDVehicle 10A, which will be described in detail in the following description. It will be understood that Record Strip 22 may, for example, comprise a strip of paper but may be formed by any surface or material capable of accepting and retaining a mark made or generated by the EDVehicle 10A.

Also, as illustrated generally in FIG. 1C and as is well known in the classic Newtonian motion experiments, the Path 20 typically includes a least a ramp section that the EDVehicle 10A travels down from a standing start and which provides an Acceleration Force 24 along the Longitudinal Axis 26 of the EDVehicle 10A wherein the Acceleration Force 24 is provided by gravity acting on the EDVehicle 10A and is dependent upon the incline or slope of the ramp. As is also well known, the Path 20 may also include horizontal sections and may include one or more upwardly sloping sections to demonstration deceleration of the vehicle.

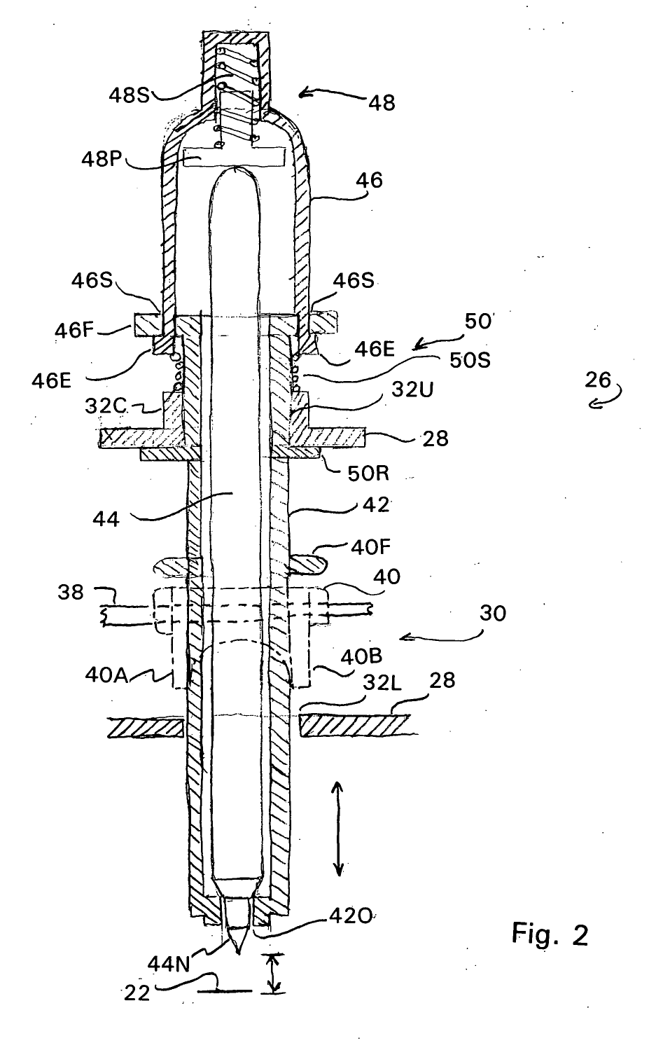

As illustrated in FIGS. 1A, 1B and 2, Measurement Mechanism 18 includes a vertically oriented Reciprocating Marker Assembly 26, slidably mounted to a Frame Assembly 28, with a Reciprocating Driver 30 arranged to periodically drive Reciprocating Marker Assembly 26, in a vertical reciprocating motion with respect to Frame Assembly 28.

As shown in FIGS. 1A, 1B and 2, Frame Assembly 28 is a generally L-shaped assembly which includes a Vertical Section 28V which has a lower end thereof mounted or permanently attached to Body 12. The opposite end of Vertical Section 28V is connected to a horizontally extending Horizontal Section 28H, of Frame Assembly 28, which has an Upper Opening 32U formed therein. A portion of Upper Surface 12U of Body 12, located beneath Horizontal Section 28H of Frame Assembly 28, has a Lower Opening 32L formed therein which extends through of Body 12. As shown in FIG. 2, for example, Upper Opening 32U and Lower Opening 32L are both coincident with one another and sized and oriented so that Reciprocating Marker Assembly 26 is slidably movable along the vertical axis of Frame Assembly 28 to and fro through both of the Upper Opening 32U and Lower Opening 32L in a reciprocal fashion.

In present embodiments of Vertical Section 28V and Horizontal Section 28H of Frame Assembly 28 may comprise two pieces fastened together by, for example, screws, rivets, glue, adhesive of any of a variety of types or may be formed as a unitary single molded element or component. Frame Assembly 28 will typically also include a Brace 28B on each side thereof wherein each Brace 28B connects Horizontal Section 28H with Vertical Section 28V to reinforce the structure of Frame Assembly 28. Again, Braces 28B may be integrally molded, as one part, with either or both of Horizontal Section 28H with Vertical Section 28V or may be attached to either or both of Horizontal Section 28H with Vertical Section 28V by any of a variety of conventional mechanical or adhesive elements or techniques. The important aspect of Frame Assembly 28 is that this assembly supports Reciprocating Marker Assembly 26 so that the marker assembly is able to reciprocate to and fro along a vertical axis and suitably mark Record Strip 22 as EDVehicle 10A travels along Path 20.

In a present embodiment of the invention, as also illustrated in FIGS. 1A, 1B and 2, Reciprocating Driver Assembly 30 includes a Motor 34 and Drive Train 36 mounted to Vertical Section 28V of Frame Assembly 28. Motor 34 is a typically a low voltage (battery powered) electric motor and Drive Train 36 is typically a gear train reducing the rotational output speed of Motor 34 to a predetermined final rotational output speed, which may be, for example, in the range of between 0.1 rps and or 1.0 rps (revolutions per second). As the gear train is conventional and well known in the art, a further detail description concerning the same is not provided. The Motor 34 is typically powered, for example, by a Battery or Batteries 34B residing a Battery Compartment 34C which will typically be formed by an appropriately shaped recess formed in the upper surface of Body 12 and provided with the appropriate and conventional electrical contacts and wiring, including an associated on/off switch for conveniently turning the electrical power for Motor 34 “on” and “off” as desired by the student. In this regard, it should be noted that Battery Compartment 34C is preferably located so as to balance the weight on each of the Wheels 16, so that the weight of is fairly evenly distributed on EDVehicle 10A and the rolling motion of EDVehicle 10A is as even as possible.

Drive Train 36 rotationally drives, through a series of gears thereof, a first end of a Rotational Shaft 38 while the opposite second end of the shaft is typically supported by, for example, a Shaft Support 38S, to ensure an orthogonal and offset alignment of Rotational Shaft 38 with respect to Reciprocating Marker Assembly 26. Shaft Support 38S captively retains the second end of Rotational Shaft 38 but allows the Rotational Shaft 38 to rotate freely with respect to Shaft Support 38S. As shown, a Reciprocal Driver 40 is mounted on Rotational Shaft 38 to rotate along with Rotational Shaft 38 and periodically engage Reciprocating Marker Assembly 26 as Rotational Shaft 38 rotates at a speed determined by Motor 34 and Drive Train 36 and, as will be described below in further detail, thereby cause a periodic vertical reciprocating motion of Reciprocating Marker Assembly 26.

Referring now to FIG. 2, this drawing is a cross sectional view of Reciprocating Marker Assembly 26 which, as previously described, extends vertically through Upper Opening 32U and Lower Opening 32L of Frame Assembly 28. Reciprocating Marker Assembly 26 includes a generally cylindrical Marker Holder 42 for captively receiving and retaining or holding a conventional Marker 44, such as a felt tip pen, with the writing Nib 44N of the Marker 44 extending through a Nib Opening 42O at the lower end of Marker Holder 42. Nib Opening 42O is shaped or contoured to retain Marker 44 at a marking position relative to the lower end of Marker Holder 42 so as to facilitate contact of writing Nib 44N of the Marker 44 with a Record Strip 22, or a similar surface, when Reciprocating Marker Assembly 26 reciprocates vertically, as will be described below.

As also shown in FIG. 2, the upper end of Marker Holder 42 is closed by a removable Retainer Cap 46 that releasably engages with the upper end of Marker Holder 42 so as to retain Marker 44 within Marker Holder 42 with writing Nib 44N positioned vertically, at the correct height, so as to allow Nib 44N to contact the Record Strip 22 when Reciprocating Marker Assembly 26 is depressed, by Shaft Support 38S of Rotational Shaft 38, to its lowest vertical position. In the embodiment illustrated in FIG. 2, the lower circumferential edge of Retainer Cap 46 is provided with Bayonet Lock Extensions 46E that engage with corresponding Bayonet Lock Slots 46S formed in a Locking Flange 46F extending circumferentially outwards from the upper end of Marker Holder 42. As also shown, in a present embodiment Retainer Cap 46 further includes an Axial Biasing Element 48 that resiliently biases Marker 44 in the vertical downward direction toward Nib Opening 42O and thereby toward the lower end of Marker Holder 42 so that the writing Nib 44N of Marker 44 is correctly positioned to contact and mark Record Strip 22. Axial Biasing Element 48 thereby allows vertical movement of the Marker 44 when the Nib 44N of the Marker 44 comes into contact with the Record Strip 22, or other horizontal surface, when Reciprocating Marker Assembly 26 is forced downward to generate or create a mark thereon, thereby preventing Nib 44N from being driven into the Record Strip 22 or other surface with too great a force and ruining or destroying Nib 44N of the Marker 44. As indicated, in a present embodiment, and for example, Axial Biasing Element 48 generally comprises a T-shaped Plunger 48P having a substantially planar end engaging with the top of Marker 44 and a shaft engaging with an Axial Bias Spring 48S that bears against the inside top of Retainer Cap 46. Axial Biasing Element 48 also allows Marker Holder 42 to enclose and accommodate different length Markers 44 therein with still biasing Nib 44N through Nib Opening 42O.

As described above, Reciprocating Marker Assembly 26 with the enclosed Marker 44 is driven vertically in a reciprocating motion at a predetermined reciprocation rate in order to cause Marker 44 to generate or create marks on a Record Strip 22 or other surface at equal time intervals. The mechanism that causes and controls this motion includes Reciprocating Driver Assembly 30 with Reciprocal Driver 40 which, as will be discussed below, periodically drives Reciprocating Marker Assembly 26 with the enclosed Marker 44 toward a lower most downward position, closely adjacent Record Strip 22, and a Return Spring Assembly 50 that returns Reciprocating Marker Assembly 26 with the enclosed Marker 44 to an upper most position remote from Record Strip 22.

First considering Return Spring Assembly 50, in a present embodiment as shown in FIG. 2, Return Spring Assembly 50 includes a Return Spring 50S surrounding the upper part of Marker Holder 42, between Locking Flange 46F and Upper Opening 32U formed in Horizontal Section 28H of Frame Assembly 28. Return Spring 50S exerts a resilient force between the lower surface of Locking Flange 46F and upper surface of Horizontal Section 28H to bias Reciprocating Marker Assembly 26 to a maximum extended upward position, e.g., to a position which is remote from furthest away from both Body 12 and Record Strip 22. In a present embodiment, as shown in FIG. 2, Upper Opening 32U may be surrounded by a Collar 32C to better confine and the reduce sideways motion of Reciprocating Marker Assembly 26 during its vertical travel. If Collar 32C is employed, Return Spring 50S bears against the a top upper end of Collar 32C and Collar 32C helps ensures that the reciprocating motion of Reciprocating Marker Assembly 26 is primarily vertical along the vertical axis V and not at an angle thereto.

The maximum upper position of Reciprocating Marker Assembly 26 due to Return Spring 50S is restrained, however, by a Retainer Flange 50R that extends circumferentially radially outward from Marker Holder 42 below the lower side of Upper Surface 12U of Body 12. As may be seen from FIGS. 1A, 1B and 2, Retainer Flange 50R will come into contact with an undersurface of Upper Surface 12U to limit the upward motion of Reciprocating Marker Assembly 26.

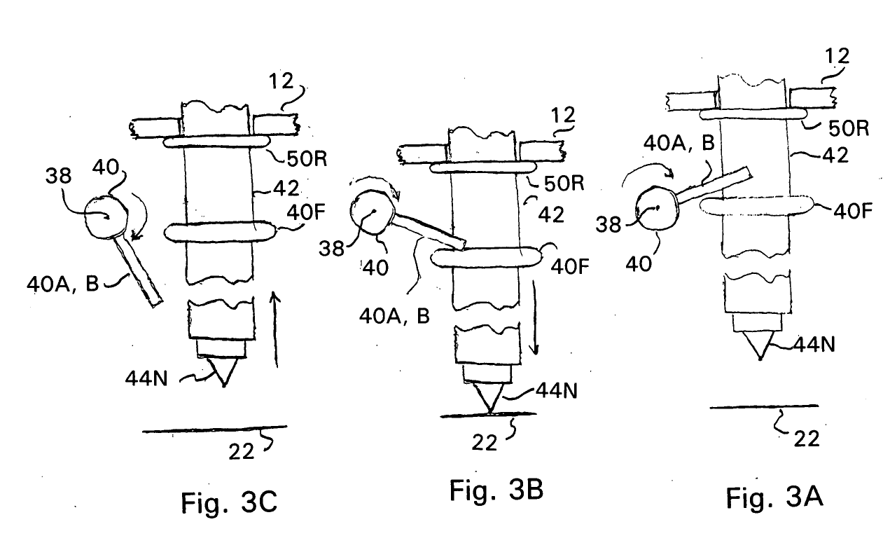

Referring now to FIGS. 1A, 1B and 2 and to FIGS. 3A, 3B and 3C, Reciprocal Driver 40 is mounted on Rotational Shaft 38 to periodically engage Reciprocating Marker Assembly 26, as Rotational Shaft 38 rotates at a known speed, and to thereby cause a periodic vertical downward reciprocating motion of Reciprocating Marker Assembly 26 with Reciprocating Marker Assembly 26 being return to its uppermost position by Return Spring 50S, thereby resulting in Reciprocating Marker Assembly 26 first moving downward and then returning upward in a repeating cyclical fashion.

As shown in FIGS. 1A, 1B, 2 and 3A-3C, the rotational axis of Rotational Shaft 38 and thus of Reciprocal Driver 40 are offset with respect to the axis of Reciprocating Marker Assembly 26 and Marker Holder 42 with a pair of Driver Arms 40A and 40B of Reciprocal Driver 40 being spaced apart by a distance slightly greater than the diameter of Marker Holder 42 and the Driver Arms 40A and 40B have a length sufficient to engage the upper surface of a Driver Flange 40F extending radially outward from Marker Holder 42. As shown by the drawing sequence in FIGS. 3A-3C, Rotational Shaft 38 and Reciprocal Driver 40 are driven by Motor 34 and Drive Train 36 at a constant rotational speed, e.g., 1 revolution per second, and in a single rotational direction so that Driver Arms 40A and 40B of Reciprocal Driver 40 come into contact, or engage, with the upper surface of Driver Flange 40F (see FIG. 3A). As rotation of Reciprocal Driver 40 by Motor 34 and Drive Train 36 continues, Reciprocal Driver 40 forces Driver Flange 40F and thus Marker Holder 42 and Reciprocating Marker Assembly 26 in a downward direction toward Record Strip 22. The engagement of Driver Arms 40A and 40B with Driver Flange 40F and the downward motion of Marker Holder 42 continues with continued rotation of Rotational Shaft 38 and Reciprocal Driver 40 until Marker Holder 42 and thus Nib 44N of Marker 44 reaches its lowest point of travel of Reciprocating Marker Assembly 26, whereupon Nib 44N contacts Record Strip 22, or an equivalent surface, and deposits or creates a mark thereon (see FIG. 3B).

At this point, Driver Arms 40A and 40B disengage from Driver Flange 44F (see FIG. 3C), whereupon Return Spring 50S, acting upon Marker Holder 42, returns Reciprocating Marker Assembly 26 with Marker 44 back to its uppermost position (see FIG. 3A) whereby the Driver Arms 40A and 40B continue their rotational movement until they again engage with Driver Flange 44F and commence another marking cycle. The time result is thereby a succession of marks, made at equal time intervals, on the Record Strip 22 or other equivalent surface as the EDVehicle 10A travels along the Record Strip 22.

It will be recognized that the vertical distance traveled by Reciprocating Marker Assembly 26 with Marker 44 during each vertical stroke and the length of the interval during which the Nib 44N of the Marker 44 is in contact with a Record Strip 22 is dependent upon the length and width of Driver Arms 40A and 40B, the width of Driver Flange 44F, and such factors as the offset distance between Driver Shaft 38 and Marker Holder 42. It will also be recognized that the reciprocating frequency of Reciprocating Marker Assembly 26 and thus the time interval between marks made by the Marker 44, and to a certain extend the width of such marks, is dependent upon these factors as well as the rotational speed of Motor 34 and the gear reducing of Drive Train 36. It will also be recognized, however, that these values are readily calculated and adjusted and are readily adapted to the needs of the design requirements of a given EDVehicle 10A.

It will also be recognized that an EDVehicle 10A of the present invention is not only significantly less expensive than other options, but will provide a significant improvement in the accuracy and repeatability of results in experiments of the types for which an EDVehicle 10A is suitable, such a experiments to demonstrate or prove Newton's laws.

It is further recognized, however, that in certain circumstances, such as in higher levels of high school or beginning college or in more advanced settings, it is desirable to further reduce the dependence upon reliance upon direct human reading and interpretation of data, such as measuring the location of marks along a Record Strip 22, but without significantly increasing the cost of a EDVehicle 10A.

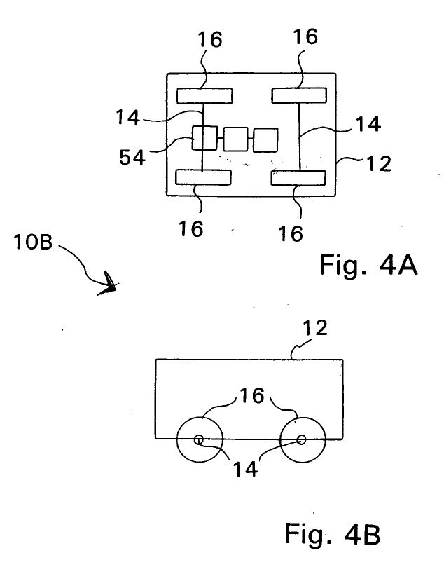

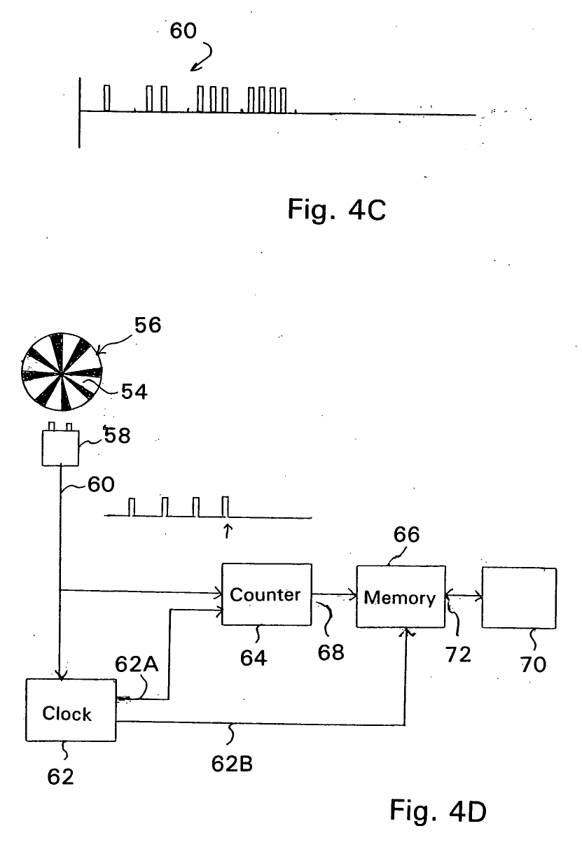

An alternate embodiment of an EDVehicle 10A meeting these requirements, referred to hereafter as EDVehicle 10B, is illustrated in FIGS. 4A and 4B. [045] It was described herein above that an EDVehicle 10A determines equal units of time, by the operation of the Reciprocating Marker Assembly 26, and measures and records the distance traveled during each of the equal time units, via the marks formed on the Record Strip 20 by the Reciprocating Marker Assembly 26. As will be described in the following description, in this embodiment the Measurement Mechanism 18 of the EDVehicle 10B again measures distance per time interval during movement of the EDVehicle 10B along a Path 20, but does so by counting the number of equal units of distance traveled during each of a sequence of equal time intervals. The EDVehicle 10B also records the measurements in a memory device, from which this information can then be subsequently read, rather than indicating the distance traveled per time interval by visual indications on a Record Strip 22 or other recording surface.

As may be seen in FIGS. 4A and 4B, an EDVehicle 10B again essentially comprises a car-like Body 12 with a pair of spaced apart Axles 14 wherein each Axle 14 has a Wheel 16 fixedly secured to each end thereof and wherein the Body 12 is typically in the shape of a rectangular box having a top but open at the bottom. As with the previous embodiment, it is to be appreciated that other types, sizes, shapes, etc., and other modification of vehicle would also be suitable for use with the present invention. In the EDVehicle 10B embodiment of the present invention, the Measurement Mechanism 18 includes a Velocity Indicator Disk 54 mounted on one of Axles 14, typically the rear Axle 14, to rotate along with Wheels 16 when the EDVehicle 10B moves down an inclined or sloped surface along a Path 20. As indicated, an exterior surface of Velocity Indicator Disk 54 is provided with a Velocity Code Markings 56, e.g., alternating eight white and eight black strips, indicating equal segments of distance around the circumference Velocity Indicator Disk 54. The passage of the markings of Velocity Code Markings 56, past a fixed circumferential reference point, e.g., Marking Sensor 58, thereby indicates the speed of rotation of Axle 14 and Wheels 16 so that the speed of EDVehicle 10B, along a Path 20 as a function of number of segments of the Visual Code Marking 56 passing that reference point per unit time and the diameter of Wheels 16, and the distance traveled by EDVehicle 10B if the total marks passed that point are counted.

In a present embodiment, and as illustrated, Velocity Indicator Disk 54 is cylindrical drum, having a diameter of about ¾ of an inch or so, which is permanent affixed to one Axle 14 so as to rotate along with the Axle 14 and Wheels 16. The segments of the Velocity Code Markings 56 are provided on the outer circumferential surface of the cylindrical drum and the reference point is permanently affixed to preferably an undersurface of the Body 12 and positioned sufficiently close to the outer circumferential surface of the cylindrical drum to facilitate detection of the segments of the Velocity Code Markings 56. If desired, the reference point may be permanently affixed to a top surface of the Body 12 and view the Velocity Code Markings 56 provided on the outer circumferential surface of the cylindrical drum through a sight hole provided in Body 12 as long as the reference point is positioned sufficiently close to Velocity Code Markings 56 so as to facilitate detection of the segments thereon. Velocity Code Markings 56 are detected as Velocity Indicator Disk 54 rotates by means of a Marking Sensor 58 in proximity to Velocity Indicator Disk 54, which generates a Velocity Output 60 typically comprising a sequence of pulses wherein a pulse is generated for each Visual Code Marking 56 passing the Marking Sensor 58. As illustrated in FIG. 4C, therefore, the number of pulses generated per unit time is therefore dependent upon the velocity of motion of the EDVehicle 10B along the Path 20, so that a count of the number of pulses occurring in each unit of time will indicate the speed of the EDVehicle 10B.

In a present embodiment, the Marking Sensor 58 comprises a light source, such as a light emitting diode, and a photodetector mutually aimed at a fixed point or area on the exterior circumference of Velocity Indicator Disk 54 through which the Velocity Code Markings 56 will pass or travel when the EDVehicle 10B is in motion. In other embodiments, for example, Velocity Code Markings 56 may comprise, for example, magnetic areas or elements on the exterior circumference of Velocity Indicator Disk 54 and Marking Sensor 58 will be a magnetic sensor detecting the passing of the magnetic Velocity Code Markings 56, rather than an optical sensor. It will be understood by those of ordinary skill in the relevant arts, however, that there is a variety of markings and marking sensors that can fulfill these functions and perform these operations and such other modified arrangements are considered to be within the spirit and scope of the present invention.

As indicated in FIG. 4D, the Measurement Mechanism 18 of the EDVehicle 10B further includes a Clock 62 generating Clock Outputs 62A and 62B to, respectively, a Counter 64, which also receives Velocity Output 60 from Marking Sensor 58, and a Memory 66, which also receives an Count Per Unit Time Output 68 from Counter 64. Counter 64 counts the number of Velocity Code Markings 56 detected during each equal sequential time interval, as generated by Clock Output 62A from Clock 62. At the end of each such time interval indicated by Clock Output 62A, Counter 64 generates a resulting Count Per Unit Time Output 68 to Memory 66, which is clocked into and stored in Memory 66 by Clock Output 62B of Clock 62.

As discussed above, therefore, each Count Per Unit Time Output 68 thereby represents the number of Velocity Code Markings 56 detected by Marking Sensor 58 during a corresponding time interval, and thus the velocity of the EDVehicle 10B along the Path 20 during that time interval. A sequence of Count Per Unit Time Outputs 68 thereby represents the velocity and variations in velocity, that is, due to acceleration or deceleration, of the EDVehicle 10B along the Path 20, and the Count Per Unit Time Outputs 68 stored in Memory 66 may subsequently be read out to a Computer 70, or a printer, through a Port 72 using any of the conventional methods or mechanisms well known in the relevant arts. The data read from Memory 66 may then be employed in computing and graphing the velocity and acceleration or deceleration of the EDVehicle 10B during the course of the experiment.

In this regard, it should be noted that the accuracy of the data may be improved if the starting point of the vehicle is synchronized with Velocity Code Markings 56 on Velocity Indicator Disk 54, that is, if the vehicle starts at the same point each time with respect to rotation of the Velocity Indicator Disk 54. This may be accomplished with the aid of an Position Indicator 74, which may be, for example, a light emitting diode, connected from the output of Marking Sensor 58. That is, Velocity Code Markings 56 may typically take the form of alternate “white” and “black” regions around the circumference of Velocity Indicator Disk 54 so that Position Indicator 74 may be, for example, “on” for a “white” region and “off” for a “black” region or vice versa. The vehicle, that is, Wheels 16 and Axle 14, may thereby be positioned at the boundary between adjacent markings of Velocity Code Markings 56 by rotating the Wheels 16 until Position Indicator 74 indicates that Velocity Indicator Disk 54 is positioned so that Velocity Code Markings 56 and thus the Wheels 16 are at the transition between a “white” region and the adjacent “black” region, thereby insuring that the count begins at the same relative point for each experiment.

Since certain changes may be made in the above described method and system without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A vehicle for performing an experiment demonstrating a Newtonian law of motion, including capturing data representing vehicle velocity over time during execution of an experiment, the vehicle comprising:
an interval timer for generating a time interval output representing equal intervals of time;
a velocity indicating mechanism for generating a velocity output representing a velocity of the vehicle when traveling along a path during performance of the experiment; and
a memory mechanism for recording the time interval output and the velocity output during performance of the experiment, the recorded time interval output and velocity output being recorded for use in at least one calculation demonstrating the Newtonian law of motion.

2. The vehicle of claim 1, wherein:
the interval time includes:
a motor and drive train rotationally driving a reciprocal driver at a fixed rotational rate, the reciprocal driver having at least one driver arm extending therefrom;
the velocity indicating mechanism includes:
a marker for making a visual indication on a surface contacted by the marker;
a reciprocating marker holder slidably mounted in the vehicle for a vertical reciprocating motion, the marker being retrained in the marker holder and the marker holder including a driver flange extending radially from the marker holder to be periodically engaged by the at least one driver arm of the reciprocating driver; and
the memory mechanism is a recording strip extending along the path traveled by the vehicle during performance of the experiment,
such that rotation of the reciprocating driver drives the at least one driver arm into periodic engagement with the drive flange of the marker holder at fixed intervals determined by the rotational rate of the reciprocating driver; and
upon each engagement of the driver flange by the at least one driver arm, the marker holder is driver vertically downward so that the marker contacts the recording strip and makes a corresponding visual indication thereupon so that a distance between successive visual indications, represents a velocity of the vehicle along the path traveled during performance of the experiment, can be determined.

3. The vehicle of claim 2, wherein:
the vehicle further includes a frame for slidably mounting the reciprocating marker holder in the vehicle for a vertical reciprocating motion.

4. The vehicle of claim 2, wherein:
the velocity indicating mechanism further includes a return spring engaging between the reciprocating marker holder and the vehicle for returning the reciprocating marker holder to an upper vertical position when the at least one driver arm of the reciprocating driver disengages from the driver flange of the reciprocating marker holder.

5. The vehicle of claim 2, wherein:
the reciprocating marker holder further includes
a retainer cap located at an upper end of the reciprocating marker holder for retaining the marker in the reciprocating marker holder; and
a bias spring located between the retainer cap and the marker for resiliently biasing the marker towards a lowermost position within the reciprocating marker holder so that a nib of the marker extends downwards through a nib opening in a bottom end of the reciprocating marker holder.

6. The vehicle of claim 1, wherein:
the interval timer includes
a clock generating a clock output at fixed time intervals,
the velocity indicating mechanism includes
a velocity indicator generating a velocity code output representing a sequence of equal distance intervals along the path at a rate representative of a velocity of the vehicle along a path during performance of the experiment, and
a counter responsive to the velocity code output and the clock output for counting a number of equal distance intervals occurring during each fixed time interval and generating a corresponding counter output; and
the memory mechanism includes a memory responsive to the counter output and to the clock output for storing a counter output for each fixed time interval;
such that each recorded counter output represents a number of equal distance intervals traveled by the vehicle during a corresponding fixed time interval and the recorded counter outputs may be subsequently read from the memory for use in at least one calculation for demonstrating the Newtonian law of motion.

7. The vehicle of claim 6, wherein:
the velocity indicator includes a disk mounted on an axle of the vehicle to rotate at a rate determined by a rate of rotation of at least one wheel of the vehicle as the vehicle travels along the path during performance of the experiment; and
the velocity code output is generated by velocity code markings located on a circumference of the disk and sensed by a code marking sensor so that the velocity code output is a sequence of pulses indicating equal distance intervals traveled by the vehicle during performance of the experiment.
